(19) United States
(12) Patent Application Publication
(10) Pub. No.: US 2025/0235018 A1
(43) Pub. Date: Jul. 24, 2025

(54) SPLICED AND MOLDED PILLOW CORE AND MOLDING METHOD THEREOF

(71) Applicant: Tenafei Technology Co., Ltd., Kunshan (CN)

(72) Inventors: Gang YE, Kunshan (CN); Xianming MEI, Kunshan (CN); Zeng HE, Kunshan (CN)

(73) Assignee: Tenafei Technology Co., Ltd., Kunshan (CN)

(21) Appl. No.: 18/019,099

(22) PCT Filed: Dec. 28, 2022
(86) PCT No.: PCT/CN2022/142797

§ 371 Date: Feb. 1, 2023

(30) Foreign Application Priority Data
Oct. 13, 2022 (CN) 202211253330.2

(51) Int. Cl. A47G 9/10; B29C 65/00; B29C 69/00; B29L 31/00

(52) U.S. Cl. CPC A47G 9/10; B29C 65/002; B29C 69/001; B29L 2031/751

(57) ABSTRACT

The present disclosure provides a spliced and molded pillow core and a molding method thereof. The spliced and molded pillow core includes a spliced pillow core molded by splicing a plurality of splicing blocks, the spliced pillow core is integrally formed by molding, and base materials of at least two splicing blocks are different. The present disclosure adopts a differentiated base material for splicing and molding, so as to provide a pillow area with abundant elastic differences to the pillow core, and to meet the demand combining high rebounding and slow rebounding; and the pillow core is more comfortable to use. By combining an adhesive with tenon-and-mortise, the molded structure of the pillow core is more reliable and stable, the effective service life is prolonged, and at the same time the division of the pillow area is more reasonable, so as to provide the abundant differentiated support demand. An internal sealing plastic bag is provided, to realize the combination of a profiling support in the headrest area and the slow rebounding, so the headrest is more comfortable, and at the same time, a heat exchange function is also provided, so as to meet a certain temperature self-adaptive regulation and comfort demands. The manufacturing and processing are convenient and high-efficiency, and the batch line operation is easy to be realized, with a higher economic value.

### TECHNICAL FIELD

The present disclosure relates to a spliced and molded pillow core and a molding method thereof, belonging to the technical field of the pillow core and the processing method thereof.

### BACKGROUND

A pillow is a sleeping tool. It is generally recognized that the pillow is a filler adopted for comfortable sleeping. The spine of the human body is known from the modern medicine study, and the spine is a straight line from the front, but a curve with four physiological curvatures from the side. In order to protect the normal physiological curvature of the neck and maintain the normal physiological activity of people during sleeping, the pillow must be used during sleeping.

The traditional pillow is usually formed by filling cotton, buckwheat and the like in a pillowslip. However, with the improvement of people's living standards and material development, more and more pillows adopt pillow cores molded by latex, bionic cotton and the like. This type of pillow core has a certain fixed form to meet an implementation requirement of a specific concave-convex function area, and the surface concave-convex can adopt to the human physiological curve, so the sleeping is more comfortable.

The molded pillow core is usually molded by adopting polyurethane and other materials. However, based on material characteristics, elasticity of the molded pillow is more uniform, and a local elastic difference is implemented through a molded height difference. The elastic distribution, the air permeability and the like of the pillow core molded by a single profile are hard to meet the comfort demand.

In addition, there are also many pillow cores with internal function bodies at present, a heating module, a carbon bag and the like are disposed in the pillow core, and these function bodies will also affect the elasticity of the pillow core, so as not to provide a more comfortable elastic support.

### SUMMARY

In order to solve the deficiencies of the prior art and for a problem that a traditional molded pillow core cannot provide an abundant contact body feeling due to a single base material, the present disclosure provides a spliced and molded pillow core and a molding method thereof.

In order to implement the above purpose, the present disclosure adopts the technical solution below:

A spliced and molded pillow core, including a spliced pillow core molded by splicing a plurality of splicing blocks, the spliced pillow core is integrally formed by molding, and base materials of at least two splicing blocks are different.

Preferably, the different base materials at least include different elastic force of the base materials.

Preferably, the spliced pillow core is provided with a headrest area and two side pillow areas, the spliced pillow core includes two splicing blocks that are arranged correspondingly to the side pillow areas one by one and at least one splicing block arranged correspondingly to the headrest area.

Preferably, two sides of the headrest area are respectively provided with a first direction pillow area and a second direction pillow area, and the first direction pillow area and the second direction pillow area are respectively provided with the correspondingly arranged splicing blocks.

Preferably, any adjacent splicing blocks are adhered to each other.

Preferably, a tenon-and-mortise splicing structure is provided between at least two adjacent splicing blocks.

Preferably, a splicing base is arranged at a bottom of the spliced pillow core, a containing cavity slot is provided between the spliced pillow core and the splicing base, a sealing plastic bag filled with a fluid medium is arranged inside the containing cavity slot, and the spliced pillow core and the splicing base are integrally formed by molding.

The present disclosure further provides a molding method for a spliced and molded pillow core, and the method includes the following steps of:
S1: selecting and cutting splicing blocks, selecting corresponding base materials based on an elastic demand for a pillow area of the spliced pillow core, and cutting the base materials into the splicing blocks;
S2: forming the spliced pillow core, splicing and adhering a plurality of splicing blocks to form the spliced pillow core integrally; and
S3: molding, molding the spliced pillow core through a molding device, so as to obtain the molded pillow core.

Preferably, a splicing base is arranged at a bottom of the spliced pillow core, a containing cavity slot is provided between the spliced pillow core and the splicing base, and a sealing plastic bag filled with a fluid medium is arranged inside the containing cavity slot.

In S1, the cutting and forming of the splicing base is performed, and processing and forming of a slot position for forming the containing cavity slot are performed on the splicing base and the plurality of splicing blocks;

In S2, the sealing plastic bag is placed in the containing cavity slot and the spliced pillow core is adhered to the splicing base.

The beneficial effects of present disclosure are mainly reflected as follows:

1. The differentiated base material is adopted for splicing and molding, so as to provide the pillow area with the abundant elastic difference to the pillow core, and to meet the demand combining high rebounding and slow rebounding; and the pillow core is more comfortable to use.

2. By combining an adhesive with tenon-and-mortise, the molded structure of the pillow core is more reliable and stable, the effective service life is prolonged, and at the same time the division of the pillow area is more reasonable, so as to provide the abundant differentiated support demand.

3. The internal sealing plastic bag is provided, to realize the combination of a profiling support in the headrest area and the slow rebounding, the headrest is more comfortable, and at the same time, a heat exchange function is also provided, so as to meet a certain temperature self-adaptive regulation and comfort demands.

4. The manufacturing and processing are convenient and high-efficiency, and the batch line operation is easy to be realized, with a higher economic value.

### BRIEF DESCRIPTION OF THE DRAWINGS

By reading the detail descriptions made to non-restrictive embodiments with reference to the following drawings, other features, objectives and advantages of the present disclosure will be more obvious:

FIG. 1 is a structural schematic diagram of a spliced and molded pillow core in Embodiment I of the present disclosure.

FIG. 2 is a schematic diagram of an exploded structure of a spliced and molded pillow core in Embodiment I of the present disclosure.

FIG. 3 is a schematic diagram of an exploded structure of a spliced and molded pillow core in Embodiment II of the present disclosure.

FIG. 4 is a schematic diagram of an exploded structure of a spliced and molded pillow core in Embodiment III of the present disclosure.

FIG. 5 is a flow chart of a molding method for a spliced and molded pillow core of the present disclosure.

### DETAILED DESCRIPTION OF THE EMBODIMENTS

In order to make the objectives, technical solutions and advantages of the present disclosure clearer, the technical solutions in the embodiments of the present disclosure are clearly and completely elaborated below in combination with the drawings in the embodiments of the present disclosure. It is apparent that the described embodiments are a part of the embodiments of the present disclosure but not all. Based on the embodiments of the present disclosure, all the other embodiments obtained by those of ordinary skill in the art on the premise of not contributing creative effort should belong to the protection scope of the present disclosure.

The present disclosure is further described below in combination with drawings and embodiments. It is understood that the specific embodiments described herein are merely used to explain the related invention, instead of limiting the invention. In addition, it also needs to note that, for easy description, some parts related to the invention are only illustrated in the drawings. It is noted that embodiments in the present disclosure and features in the embodiments may be combined with each other without conflict.

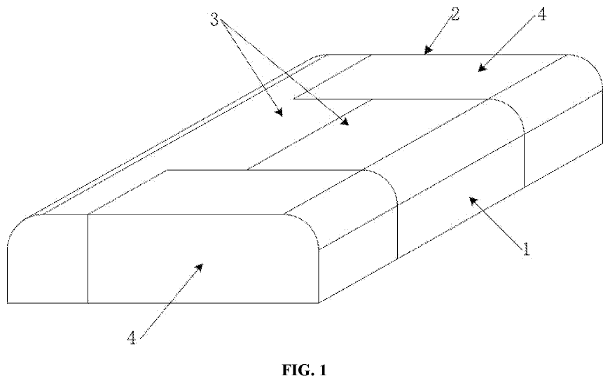

The present disclosure provides a spliced and molded pillow core, as shown in FIG. 1 to FIG. 6, the spliced and molded pillow core includes a spliced pillow core 2 molded by splicing a plurality of splicing blocks 1, the spliced pillow core 2 is integrally formed by molding, and base materials of at least two splicing blocks 1 are different.

### Specific Implementation Process and Principle Description:

The traditional pillow core is formed by adopting a single base material, the base material is generally polyurethane with excellent elasticity and stronger plasticity, and the polyurethane has many types, generally including a soft foam sponge, a hard foam sponge, a high rebounding sponge, a slow rebounding sponge, etc.

The molding base material of the pillow core generally adopts the low rebounding sponge, however the slow rebounding sponge has different elastic characteristics and processes. The polyether foam sponge and the MDI sponge also exist elasticity difference, air permeability difference and the like, the high rebounding sponge is also used frequently, and the high rebounding sponge is polyether polyol, which has super-strong rebounding and air permeability.

The traditional molding base material is single, so as not to balance the super-strong rebounding and slow rebounding.

In the present disclosure, the splicing blocks 1 with different base materials are adopted to spice and mold the spliced pillow core 2, so as to realize the demand of combining the high rebounding with the slow rebounding; and the molded pillow core has the combination of the differences of the high rebounding and low rebounding, the body feeling of the pillow area is enriched, so that the contact comfort is greatly improved.

It is noted that the different base materials at least include the different elastic force of the base materials. The different elastic force is the different rebounding characteristics, the different rebounding force and the different elastic fatigue.

In addition, the different base materials further include different air permeability, different wet aging, different thermal aging, etc.

According to the characteristics of the required base material, the splicing blocks 1 with different characteristics may be selected, the splicing blocks 1 include but are not limited to a polyurethane sponge, a latex, bionic honeycomb cotton, TPE, a carbon fiber structure and a biological fiber structure, and the pillow core base materials with different elasticity are all within the protection scope of the present disclosure. When the base materials without the thermal bonding characteristics are selected, the rubber material bonding between the splicing bodies is required for splicing.

### Embodiment I

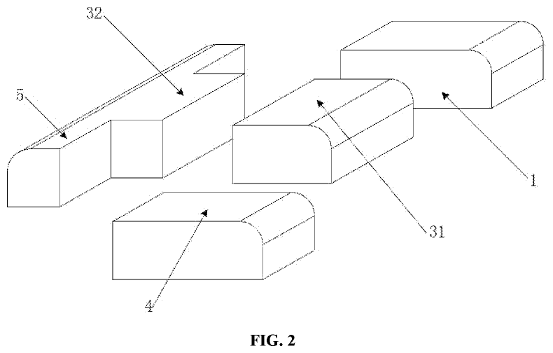

As shown in FIG. 1 and FIG. 2, a spliced pillow core 2 is provided with a headrest area 3 and two side pillow areas 4, the spliced pillow core 2 includes two splicing blocks that are arranged correspondingly to the side pillow areas 4 one by one and at least one splicing block arranged correspondingly to the headrest area 3.

Specifically, the splicing blocks corresponding to the side pillow areas 4 are high rebounding sponge, so as to meet a certain support force and rebounding demand; and however the splicing block corresponding to the headrest area 3 is slow rebounding sponge, which plays a memory rebounding function, so the headrest is more comfortable.

In a specific embodiment, two sides of the headrest area 3 are respectively provided with a first direction pillow area 31 and a second direction pillow area 32, and the first direction pillow area 31 and the second direction pillow area 32 are respectively provided with the correspondingly arranged splicing blocks.

Specifically, the pillow exists a using situation of a turned edge in a general case, however the user's comfort is also different. Therefore, in the present disclosure, the splicing blocks in the first direction pillow area 31 and the second direction pillow area 32 exist different rebounding elasticity, that is, the rebounding force of the splicing block in the first direction pillow area 31 is higher than that of the splicing block in the second direction pillow area 32, so as to meet the demand of selectivity.

It is noted that the second direction pillow area 32 is T-shaped, and provided with an extension portion 5 extending to the side pillow areas 4, the slow rebounding of the extension portion 5 may be combined with the high rebounding of the side pillow areas 4, so as to meet the slow rebounding support for the neck and shoulder and the high rebounding support for the head when lying on the side or lying on the back.

### Embodiment II

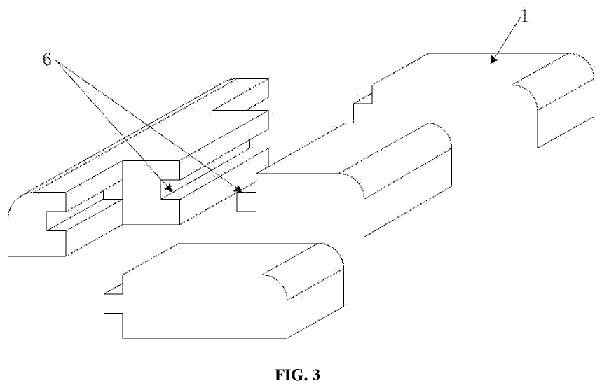

As shown in FIG. 3, any adjacent splicing blocks are adhered to each other. A tenon-and-mortise splicing structure 6 is provided between at least two adjacent splicing blocks.

Specifically, the adjacent splicing blocks are adhered and assembled through an adhesive in a general case, however the splicing blocks exist a certain hot melt setting difference, so the tenon-and-mortise splicing structure 6 is adopted, the integrated structure of the molded pillow core has better stability and is not easy to generate separation after long-term use, and the service life of the pillow core is guaranteed.

### Embodiment III

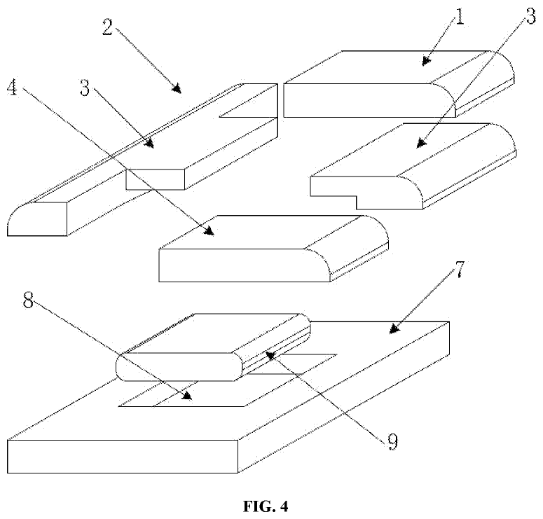

As shown in FIG. 4, a splicing base 7 is arranged at a bottom of the spliced pillow core, a containing cavity slot 8 is provided between the spliced pillow core 2 and the splicing base 7, a sealing plastic bag 9 filled with a fluid medium is arranged inside the containing cavity slot 8, and the spliced pillow core 2 and the splicing base 7 are integrally formed by molding.

Specifically, the traditional molded pillow core also exist a situation that the pillow core with function bodies inside the upper splicing body and the lower splicing body is adopted, the function bodies generally adopt a carbon bag, an electric heating device, etc.

This filling body cannot give the elastic force to the pillow core, which will affect the comfort of the pillow core. However, in this embodiment, a sealing plastic bag 9 filled with a fluid medium is adopted, generally the medium filling the fluid is water, which can be used as a certain copying support for a headrest area 3, that is, the sealing plastic bag 9 can play a support deformation copying with the head, and combine with the splicing blocks to generate the slow rebounding cooperation and meet the comfort demand of the headrest. In addition, the sealing plastic bag 9 also plays a certain thermal balance effect, and a temperature is regulated by a heat conduction method, so that the contact comfort is better.

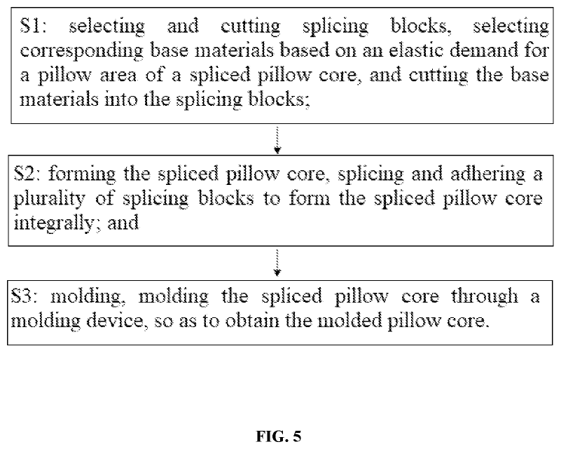

As shown in FIG. 5, which is a flow chart of a molding method for a spliced and molded pillow core, and the method includes the following steps of:
selecting and cutting splicing blocks, selecting corresponding base materials based on an elastic demand for a pillow area of the spliced pillow core, and cutting the base materials into the splicing blocks.

That is, the corresponding base materials are selected according to the elastic force demand characteristics of the headrest area 3 and the side pillow areas 4, and then the base material is cut, so as to meet the splicing and combining demands of the formed splicing blocks.

The headrest area 3 generally adopts the slow rebounding sponge base material, while the side pillow areas 4 adopt the high rebounding sponge base material.

The spliced pillow core is molded, a plurality of splicing blocks are spliced and adhered to form the spliced pillow core integrally. The splicing blocks are spliced and combined by applying adhesive, so as to form a combined matrix.

Molding, the spliced pillow core is molded through a molding device, so as to obtain the molded pillow core.

Belonging to the prior art, the molding device generally exists a support mold holder and a crimping mold holder, and the combined matrix is placed in a mold cavity for molding.

It is noted that, during molding, the surface concave-convex, texture and other molding may be performed, and different contact characteristics and elastic difference characteristics are given to the headrest area 3 and the two side pillow areas 4.

In a specific embodiment, the cutting and forming of the splicing base is performed, and processing and forming of a slot position for forming the containing cavity slot are performed on the splicing base and a plurality of splicing blocks.

The slot position is usually processed by a hot cutting mode.

A sealing plastic bag is placed in the containing cavity slot and the spliced pillow core is adhered to the splicing base. The sealing plastic bag is a sealed silicone rubber bag, which is not easy to be damaged during hot molding, and after long-term use, the toughness and strength are reliable and stable.

Through the above description, it has found that the spliced and molded pillow core and the molding method thereof adopt a differentiated base material for splicing and molding, so as to provide the pillow area with the abundant elastic different to the pillow core, and to meet the demand combining high rebounding and slow rebounding; and the pillow core is more comfortable to use. By combining the adhesive with the tenon-and-mortise, the molded structure of the pillow core is more reliable and stable, the effective service life is prolonged, and at the same time the division of the pillow area is more reasonable, so as to provide the abundant differentiated support demand. The internal sealing plastic bag is provided, to realize the combination of a profiling support in the headrest area and the slow rebounding, the headrest is more comfortable, and at the same time, a heat exchange function is also provided, so as to meet a certain temperature self-adaptive regulation and comfort demands. The manufacturing and processing are convenient and high-efficiency, and the batch line operation is easy to be realized, with a higher economic value.

The term “include” or any other similar words are intended to cover nonexclusive inclusions herein, so that a process, method, goods or equipment/device including a series of elements not only includes those elements but also includes other elements which are not clearly listed or further includes elements intrinsic to the process, the method, the goods or the equipment/the device.

So far, the technical solution of the present disclosure has been described in combination with preferred embodiment modes shown in drawings. However, those skilled in the art can easily understand that the protection scope of the present disclosure is obviously not limited to these specific implementation modes. Those skilled in the art can make equal modification or replacement to the related technical features without departing from the principles of the present disclosure; and these modified or replaced technical solutions all fall into the protection scope of the present disclosure.

What is claimed is:

1. A spliced and molded pillow core, comprising:
a spliced pillow core molded by splicing a plurality of splicing blocks, wherein the spliced pillow core is integrally formed by molding, and base materials of at least two splicing blocks are different.

2. The spliced and molded pillow core according to claim 1, wherein the different base materials at least comprise different elastic force of the base materials.

3. The spliced and molded pillow core according to claim 1, wherein the spliced pillow core is provided with a headrest area and two side pillow areas, the spliced pillow core comprises two splicing blocks that are arranged correspondingly to the side pillow areas one by one and at least one splicing block arranged correspondingly to the headrest area.

4. The spliced and molded pillow core according to claim 3, wherein two sides of the headrest area are respectively provided with a first direction pillow area and a second direction pillow area, and the first direction pillow area and the second direction pillow area are respectively provided with the correspondingly arranged splicing blocks.

5. The spliced and molded pillow core according to claim 1, wherein any adjacent splicing blocks are adhered to each other.

6. The spliced and molded pillow core according to claim 5, wherein a tenon-and-mortise splicing structure is provided between at least two adjacent splicing blocks.

7. The spliced and molded pillow core according to claim 1, wherein a splicing base is arranged at a bottom of the spliced pillow core, a containing cavity slot is provided between the spliced pillow core and the splicing base, a sealing plastic bag filled with a fluid medium is arranged inside the containing cavity slot, and the spliced pillow core and the splicing base are integrally formed by molding.

8. A molding method for a spliced and molded pillow core according to any one of claims 1 to 7, wherein the method comprises the following steps of:
S1: selecting and cutting splicing blocks, selecting corresponding base materials based on an elastic demand for a pillow area of the spliced pillow core, and cutting the base materials into the splicing blocks;
S2: forming the spliced pillow core, splicing and adhering a plurality of splicing blocks to form the spliced pillow core integrally; and
S3: molding, molding the spliced pillow core through a molding device, so as to obtain the molded pillow core.

9. The molding method for the spliced and molded pillow core according to 8, wherein a splicing base is arranged at a bottom of the spliced pillow core, a containing cavity slot is provided between the spliced pillow core and the splicing base, and a sealing plastic bag filled with a fluid medium is arranged inside the containing cavity slot;
in S1, the cutting and forming of the splicing base is performed, and processing and forming of a slot position for forming the containing cavity slot are performed on the splicing base and the plurality of splicing blocks; and
in S2, the sealing plastic bag is placed in the containing cavity slot and the spliced pillow core is adhered to the splicing base.
